(19) United States
(12) Patent Application Publication
(10) Pub. No.: US 2007/0114257 A1
(43) Pub. Date: May 24, 2007

(54) Cylinder caddy and method of use

(76) Inventor: Rodney D. Brown, Star, NC (US)

Correspondence Address: Galasso & Associates, LP, P.O. Box 26503, Austin, TX, 78755-0503, US

(21) Appl. No.: 11/284,580

(22) Filed: Nov. 22, 2005

(51) Int. Cl. B60R 9/00; B60R 7/00

(52) U.S. Cl. 224/403; 224/405

(57) ABSTRACT

A cylinder caddy for safely carrying cylinders in the bed of a pick up truck. The cylinder caddy comprises two mount sleeves and at least one horizontal bar component. The two mounting sleeves are capable of attaching to the factory installed ladder rack holes in the bed of a pick up. The horizontal bar component is attached to the mounting sleeves and is adjustable. The horizontal bar component then has clamps attached to it using an adjustable set screw. The clamps are cylindrical with one side being metal and the other side being nylon. The metal side of the clamp contains a latch mechanism capable of receiving the nylon strap. When transporting a cylinder it is placed into the clamp and locked into place using the latch mechanism.

### FIELD OF THE DISCLOSURE

A device that attaches to the bed of a pick up truck for purposes of inserting cylinders for safe transportation.

### BACKGROUND

There are lots of reasons why people want to carry cylinders comprising hazardous substances. One example that is very common is the carrying of a propane tank. There are a large number of people who own gas grills and propane cookers of some kind. Every time these cylinders need to be refilled they must be carried to a facility capable of doing it or to a facility that swaps out the cylinders. While the number of places that are capable of swapping out the cylinders is increasing, there is still the need to safely transport these cylinders from one place to another.

Scuba diving has become a very popular sport these days. In order to participate in this activity, one must have an oxygen tank. This tank must be transported to the point where the dive is going to take place. An individual divers involvement is such a sport would determine the amount of oxygen that the individual would want to keep on hand. For example, if the individual is doing a lot of diving, they may actually have large tanks that they keep stored for easy access. In this case, the large tanks would need to be refilled from time to time and could require transportation of the cylinder for this refill.

Another example of someone who has a need to carry these types of cylinder is welders. They use a combination of oxygen and sedaline in the actual function of welding. Therefore, they need to be able to safely transport these cylinders from one job site to another. While there are trucks that have been specifically modified for purposes of carrying a welding rig and the necessary equipment, there are still people who cannot afford this type of set up and therefore, make use of the vehicle they have available, i.e. a pick up truck.

It is clear that the transportation of cylinders containing potentially hazardous materials is something that takes place on a regular basis. Therefore, being able to transport these cylinders is a safe configuration is certainly something that needs to be addressed. Unfortunately, the majority of the cylinders that are transported are not necessarily done in a safe manner. Propane cylinders being the main cylinder that is transported, is usually transported by putting it in the back of a pick up truck with no restraining device or put in the trunk of a car, again with no restraining device. Alternatively, larger cylinders comprising such things as oxygen cannot be carried quite as easily. Therefore, a more sophisticated device must be used to transport these types cylinders, especially when they are full.

Presently, most of the time when one has a need for a large cylinder of to be carried somewhere, except in the case of welding supplies, the cylinders are delivered by the supplier or some make shift restraining device is used. The delivery system used by suppliers for cylinders, while not very unique, does seem to work. Because they generally are carrying a larger number of cylinders, they can tighten them together and attach them to the rail of truck where the rail has been built upward from the bed. While it still poses some danger in the delivery system, it is far better than placing a single cylinder in the back of the truck laying down to roll around.

### SUMMARY OF THE DISCLOSURE

In one embodiment the cylinder caddy comprises two mounting sleeves.

In another embodiment the mounting sleeves are capable of being installed in the ladder rack holes in the bed of a pick up truck.

In still another embodiment the cylinder caddy comprises at least two horizontal bar components.

In yet another embodiment the horizontal bar components are attached to the mounting sleeves.

In another embodiment the cylinder caddy comprises at least one clamp.

In still another embodiment the clamp is attachable to the horizontal bar component.

In yet another embodiment the cylinder caddy comprises a safety latch capable of locking a cylinder into a clamp.

In another embodiment the horizontal bar components are adjustable.

In still another embodiment the clamp is cylindrical.

In yet another embodiment one half of the clamp is comprised of a nylon strap.

In another embodiment one half of the clamp is comprised of metal.

In still another embodiment the clamp is attached to at least one of the horizontal bar components.

In yet another embodiment the safety mechanism is attached to the metal portion of the clamp.

In another embodiment the mounting sleeves and the horizontal bar components are approximately 2 inches in width.

In still another embodiment the metal clamp is attached to the horizontal bar component by an adjustment set screw.

In yet another embodiment the nylon strap threads through the locking mechanism to form to lock a cylinder into place.

### BRIEF DESCRIPTION OF THE DRAWINGS

FIG. 1 is a perspective view of a cylinder caddy.

FIG. 2 is a top view of the cylinder caddy described in FIG. 1

### DETAILED DESCRIPTION OF THE DRAWING FIGURES

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

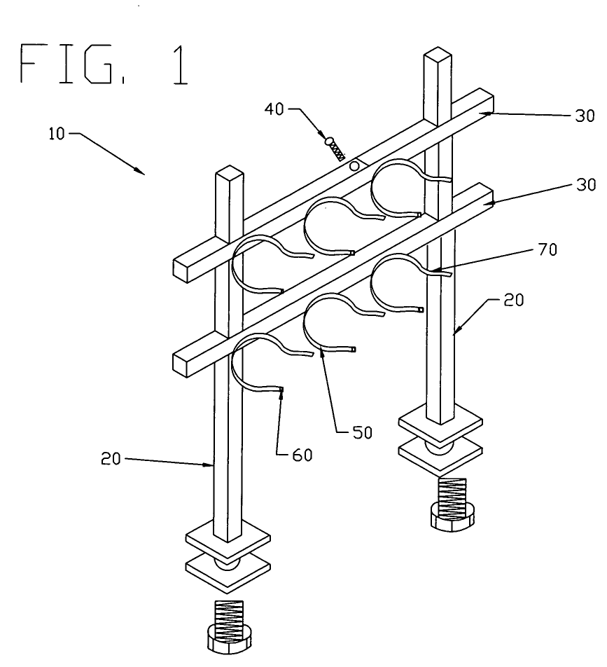

FIG. 1 illustrates a cylinder caddy 10 having two mounting sleeves 20 which are capable of being attached to the factory installed ladder rack holes in the bed of a pick up truck. Once the two mounting sleeves 20 are inserted into the ladder rack holes, the mounting sleeves 20 are attached to the pick up bed by using a threaded mounting plate and a mounting screw. After securing the mounting sleeves 20 to the ladder rack holes, then the horizontal bar components 30 can be adjusted for a proper fit across the bed of the pick up truck. An arm set screw 40 is used to the lock the horizontal bar components 30 into place. By having the horizontal bar components 30 adjustable, the cylinder caddy 10 is capable of being installed into trucks having various configurations and sizes. For example, if you have a full size pick up then the cylinder caddy 10 can be adjusted to fit a full size pick up truck. Alternatively, if you have a smaller version pick up truck then you can adjust the horizontal bar components 30 inward to the proper size of the bed of the smaller pick up. Now that medium size pick up trucks are also being made, you can adjust the horizontal bar components 30 to the varying size of the bed and therefore use the cylinder caddy 10 in most any size pick up truck. The cylinder caddy 10 could even be installed into a flat bed truck provided there was place for securing the mounting sleeves 20. The mounting sleeves 20 and the horizontal bar components 30 would be comprised of a light weight but durable material measuring approximately 2 inches in width. One material that would provide enough stability and durability would steel tubing.

Attached to each of the horizontal bar components 30 are cylindrical shaped clamps 50. The clamps 50 are used for attaching a cylinder. The clamps 50 allow a cylinder to be attached to the cylinder caddy 10 in two different spots for added holding security. There is a clamp 50 attached on each of the horizontal bar components 30. The clamp 50 is designed with a latch mechanism 60 on one side and a nylon strap 70 on the other side. In order to properly secure the cylinder into the cylinder caddy 10, the cylinder is placed in the clamp 50 and securely fastened into the clamp 50 by inserting the nylon strap 70 into the latch mechanism 60. Alternative configurations for the latch mechanism 60 might include a band and clasp system similar to an oil filter wrench. The clamp 50 can be comprised of metal capable of having a nylon strap 70 attached to one side of the clamp 50 and the other side of the clamp would comprise the latch mechanism 60.

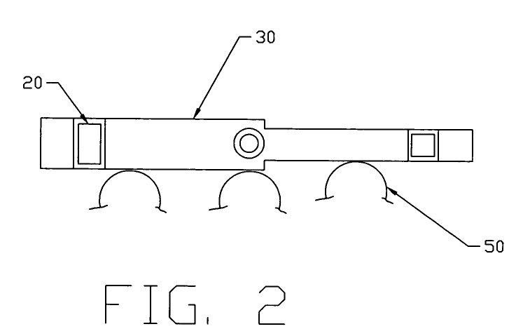

FIG. 2 is a top view of the cylinder caddy 10 which shows the horizontal bar components 30 and illustrates how the mounting sleeves 20 are configured on each end of the horizontal bar components 30. Additionally, FIG. 2 shows where the arm set screw 40 is inserted into the horizontal bar components 30 to lock the horizontal bar component 30 at the properly adjusted length.

Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

What is claimed:

1. A cylinder caddy comprising:
two mounting sleeves capable of attaching to the bed of a pick up truck;
at least two horizontal bar components attached to said mounting sleeves;
at least one clamp attached to said adjustable horizontal bar components; and
a safety latch mechanism capable of locking a container into said clamp.

2. The cylinder caddy of claim 1, wherein said horizontal bar components are adjustable.

3. The cylinder caddy of claim 1, wherein said clamp is cylindrical.

4. The cylinder caddy of claim 3, wherein one-half of the said clamp is comprised of a nylon strap.

5. The cylinder caddy of claim 4, wherein said nylon strap is operable to thread through the latch mechanism.

6. The cylinder caddy of claim 3, wherein one-half of said clamp is comprised of metal.

7. The cylinder caddy of claim 1, wherein said metal half of said clamp is attached to at least one of said horizontal bar components.

8. The cylinder caddy of claim 1, wherein said safety latch mechanism is attached to said metal portion of said clamp and operable to hold a cylinder tightly in place.

9. The cylinder caddy of claim 1, wherein said mounting sleeves and said horizontal bar components are approximately 2 inches in width.

10. The cylinder caddy of claim 1, wherein said metal clamp is attached to said horizontal bar component by an adjustment set screw.

11. A cylinder caddy system comprising:
a set of mounting sleeves capable of being attached to the bed of a pick up truck;
at least two horizontal bar component attached to said mounting sleeves;
at least one cylindrical clamp attached to said horizontal bar component; wherein said cylindrical clamp is comprised of one-half metal and one-half nylon strap; and
a safety lock mechanism capable of locking a container into said cylindrical clamp.

12. The cylinder caddy system of claim 11, wherein said horizontal bar component is adjustable.

13. The cylinder caddy system of claim 11, wherein said safety locking mechanism is attached to said metal portion of said clamp.

14. The cylinder caddy system of claim 11, wherein said mounting sleeves and said horizontal bar component measures approximately two inches in width.

15. The cylinder caddy system of claim 11, wherein said metal half of said clamp is attached to at least one of said horizontal bar components by an adjustment set screw.

16. The cylinder caddy system of claim 11, wherein said nylon strap portion is operable to feed through said latch mechanism.

17. A method of hauling cylinders having two mounting sleeves; at least one horizontal bar component; at least one clamp attached to said horizontal bar component and comprised of one-half metal and one-half nylon strap; an adjustment set screw and a safety locking mechanism; comprising the steps of:
attaching said mounting sleeves to the bed of a pick up truck;
adjusting said horizontal bar component between said mounting sleeves;
adjusting said clamp and tightening said adjustment set screw;
placing a cylinder into said clamp;
placing said nylon strap around said cylinder and into said safety latch mechanism; and
pulling the nylon strap tight around said cylinder and locking said safety latch mechanism.
